(19) United States
(12) Patent Application Publication
(10) Pub. No.: US 2017/0043196 A1
(43) Pub. Date: Feb. 16, 2017

(54) Fire Extinguishing Composition Comprising Heterocyclic Compounds

(71) Applicants: Hao WU, Shaanxi (CN); Tengfei ZHAI, Shaanxi (CN); Gaofeng ZHENG, Shaanxi (CN); Zhengjun LEI, Shaanxi (CN); Zhanjun YANG, Shaanxi (CN); Xi'an Westpeace Fire Technology Co., Ltd., Shaanxi (CN)

(72) Inventors: Hao Wu, Shaanxi (CN); Tengfei Zhai, Shaanxi (CN); Gaofeng Zheng, Shaanxi (CN); Zhengjun Lei, Shaanxi (CN); Zhanjun Yang, Shaanxi (CN)

(21) Appl. No.: 15/111,157

(22) PCT Filed: Mar. 11, 2015
(86) PCT No.: PCT/CN2015/074043

§ 371 Date: Jul. 12, 2016

(30) Foreign Application Priority Data
Jan. 13, 2014 (CN) 201410012974.1

(51) Int. Cl. A62D 1/06

(52) U.S. Cl. CPC A62D 1/06

(57) ABSTRACT

The present invention relates to a fire-extinguishing composition containing a heterocyclic compound. The fire-extinguishing composition releases a great quantity of active fire-extinguishing particles by making use of the heat generated from combustion of a pyrotechnic agent. The fire-extinguishing composition containing a heterocyclic compound in the present invention reacts at a high temperature to generate free radicals and takes reaction with one or more of O—, OH—, H— free radicals necessary for a chain combustion reaction through the free radicals, so as to cut off the chain combustion reaction and take physical and chemical inhibiting effects to jointly achieve a fire extinguishing effect at the same time. Meanwhile, it takes synergistic interaction effects with the pyrotechnic agent to further raise the fire extinguishing efficiency of the fire extinguishing agent and greatly shorten the effective fire extinguishing time.

### FIELD OF THE INVENTION

The present invention pertains to the technical field of aerosol fire distinguishing, and particularly to a thermal aerosol fire-extinguishing composition.

### BACKGROUND OF THE INVENTION

Since the specific target of each country for substitution of Halon fire extinguishing agents was put forth in Canadian Montreal Convention in 1987, all countries in the world have been committed to the research of new fire extinguishing techniques. Fire extinguishing techniques with high fire extinguishing efficiency and no environmental pollution are our aims of effort.

A gas fire extinguishing system, a powder extinguishing system, a water fire extinguishing system and the like are harmless to environment, so they are selected as substitutes of Halon fire extinguishing agents and are widely used. The fire extinguishing mechanism of the fire extinguishing systems of carbon dioxide, IG541 and inert gases mainly relies on physical fire extinguishing. The fire is put out by lowering the concentration of oxygen in the firing area. This fire extinguishing method would easily threaten human safety. The powder extinguishing system puts out a fire by spraying powder under the action of pressurized gas to contact flame and realize physical and chemical suppression effect. The water mist fire extinguishing system achieves the objects of controlling, suppressing and putting out a fire through triple actions of cooling, smothering, and isolation of thermal radiation by using water mist.

However, all these fire extinguishing systems need high pressure storage. Not only the volume is large but also there is a risk of physical explosion during storage. A document “Safety Analysis of Gas Fire Extinguishing System” (Fire Science and Technology 2002 21(5)) analyzes the risk of a gas fire extinguishing system and enumerates the safety accidents triggered by the stored pressure gas fire extinguishing system during use.

The existing thermal aerosol fire extinguishing agents are mainly type S and type K fire extinguishing agents. The comprehensive analysis of their performance and features indicates that their fire extinguishing mechanism is that the thermal aerosol fire extinguishing agents take a redox reaction through agent combustion to release a great quantity of gas and active particles and the goal of integrated chemical and physical fire extinguishing is realized through the chain scission reaction of the active particles and covering and smothering of a great quantity of gas. The disadvantage of the thermal aerosol fire extinguishing agents is that the thermal aerosol fire extinguishing agent will release a great quantity of heat while it takes the combustion reaction to release the thermal aerosol, which may cause a secondary combustion. In order to effectively reduce the temperature of the device and aerosol and avoid the secondary fire, a cooling system needs to be added. The cooling material of the existing thermal aerosol fire extinguishing devices can reduce the temperature of products, but they also greatly weaken the fire extinguishing performance of the products. In order to make up the loss on the fire extinguishing performance caused by the cooling system, many products either lower the fire extinguishing level or continuously increase the mass of the actual fire extinguishing agent, rendering the increase of product volume and the decrease of use efficiency, which results in a complex and cumbersome structure of the device, a complex technological process, a high cost, and a high nozzle temperature, which would easily cause injury to fire fighters.

### SUMMARY OF THE INVENTION

Regarding the current situation of existing fire extinguishing devices, particularly the inherent defects of an aerosol fire extinguishing system, an object of the present invention is to provide a safer and more efficient fire-extinguishing composition.

The technical scheme of the present invention is:

A fire-extinguishing composition containing a heterocyclic compound, wherein the fire-extinguishing composition contains a heterocyclic compound; the fire-extinguishing composition releases a great quantity of active fire-extinguishing particles by making use of combustion of a pyrotechnic agent.

Further, the mass content of the heterocyclic compound in the fire-extinguishing composition is 35% or above.

Further, the heterocyclic compound comprises one or more of a nitrogen-containing heterocyclic organic compound, a sulfur-containing heterocyclic organic compound and an oxygen-containing heterocyclic organic compound.

Further, the nitrogen-containing heterocyclic organic compound comprises: indazole, pyrazole, chlortrimeton, imidazole, triazole, tetrazole, pentazole, pyrazine, triazine, tetrazine, pentazine, hexazine, pyridazine, pyrimidine, piperidine, piperazine, oxazine, azepine, caprolactam, iminostilbene, diazacyclo, indole, isoindole, carbazole, benzimidazole, carboline, benzotriazole, purine, uric acid, quinoline, quinazoline, phthalazine, acridine, phenanthridine, phenazine, phenoxazine, pteridine, orthophenanthroline, 1,4-diazine, 1,4-diazabicyclo [2.2.2] octane and cyclodextrin.

Further, the sulfur-containing heterocyclic organic compound comprises: dithiane, cycloxydim, tetrahydrothiapyran-4-one, benzothiophene, dibenzothiophene, methyl 3-(aminosulfonyl)-2-thiophenecarboxylate, polythiophene, 2-thiopheneacetic acid, 5,5′-dibromo-2,2′-bisthiophene, benzothiophene-3-carbaldehyde, terthienyl, thifensulfuron, 2-bromo-5-benzoylthiophene, phenothiazine, 2-(trifluoromethyl) phenothiazine, 2-acetylphenothiazine, hydrochlorothiazide, chlorpromazine, chlorpromazine hydrochloride, promethazine hydrochloride, quinuclidine, porphyrin, tetraphenylporphyrin, protoporphyrin disodium, protoporphyrin IX dimethyl ester, protoporphyrin and copper tetraphenylporphyrin.

Further, the oxygen-containing heterocyclic organic compound comprises: trioxane, sym-trioxane, oxetane, xanthene, xanthone, 1,8-dihydroxy-3,5-dimethoxyxanthone, 1,8-dihydroxy-3,7-dimethoxyxanthone, 1-hydroxy-3,7,8-trimethoxyxanthone, 1-hydroxy-2,3,4,5-tetramethoxyxanthone, 1-hydroxy-2,3,5-trimethoxyxanthone, coumarin, thiamine tetrahydrofuryl disulfide, furazolidone, furaltadone, furadantin, furacilin, furanose, furoic acid, furosemide, furapyrimidone and dibenzofuran and benzbromarone.

Further, the fire-extinguishing composition comprises an auxiliary fire-extinguishing material.

Further, the auxiliary fire-extinguishing material comprises: brominated flame retardants, chlorinated flame retardants, organophosphorus flame retardants, phosphorus-halogen flame retardants, nitrogen flame retardants, phosphorus-nitrogen flame retardants, inorganic flame retardants or any of their combinations.

Further, the fire-extinguishing composition comprises an additive, and the content of the additive is 0.1-10%.

Further, the additive is a mold release agent, an adhesive, a catalyst or an additive with other performances, which specifically includes one or more of stearate, graphite, sodium silicate, phenolic resin, shellac, starch, dextrin, rubber, epoxy resin, acetal adhesive and hydroxypropyl methyl cellulose. In addition to the substances listed above, all other organic or inorganic substances that can realize the foregoing functions may be used as substitutes of the additive in the fire-extinguishing composition of the present invention.

Further, components of the fire-extinguishing composition and their mass percentages are:

| | |
|---|---|
| the heterocyclic compound | 35%-96% |
| the auxiliary fire-extinguishing material | 3%-60% |
| the additive | 1%-10%. |

Further, components of the fire-extinguishing composition and their mass percentages are:

| | |
|---|---|
| the heterocyclic compound | 50%-90% |
| the auxiliary fire-extinguishing material | 5%-45% |
| the additive | 2%-8%. |

The fire-extinguishing composition of the present invention adopts the following flame suppression mechanism:

During use, the pyrotechnic agent is used as a source of heat and a source of power. The heat released from ignition and combustion of the pyrotechnic agent makes the heterocyclic compound react at a high temperature to generate free radical alkyl (or aryl), free radical acyl, free radical carbonyl, S—, N— and other active fire-extinguishing particles. These active fire-extinguishing particles react with one or more of O—, OH—, H— free radicals necessary for the chain combustion reaction, thereby cutting off the chain combustion reaction. Meanwhile, they take a synergistic interaction effect with the pyrotechnic agent to further raise the fire extinguishing efficiency of the fire extinguishing agent and greatly shorten effective fire extinguishing time.

As compared with the existing thermal aerosol fire extinguishing agents, the fire-extinguishing composition of the present invention has the following advantages:
1. The heterocyclic compound in the fire-extinguishing composition of the present invention reacts at a high temperature to generate various kinds of free radicals that can effectively put out a fire, to cut off the combustion reaction chain, and work together with the reaction products of the thermal aerosol generating agent to jointly play a fire extinguishing effect, further raise the fire extinguishing efficiency of the fire extinguishing agent and shorten the effective fire extinguishing time.
2. The fire-extinguishing composition of the present invention makes use of the heat generated from the combustion of the aerosol generating agent to take the endothermic reaction fast, thereby absorbing the heat released from the combustion of the pyrotechnic agent and reducing the temperature at a nozzle of the fire extinguishing device. Therefore, the fire-extinguishing composition is safer, would not do harm to fire fighters and also avoids secondary fires.
3. An aerosol fire extinguishing device adopting the fire-extinguishing composition of the present invention does not need a cooling system with a complex structure and a large volume, so it has the characteristics of a handy structure, a simple technological process and good economy.

### DETAILED DESCRIPTION OF THE EMBODIMENTS

Below are embodiments of the present invention for illustrating a technical scheme for solving the technical problems in this application document and helping those skilled in the art understand the content of the present invention, however, the realization of the technical scheme of the present invention is not limited to these embodiments.

Add an additive to the fire-extinguishing composition of the present invention, use water as a solvent, after sieving and pelletizing, add a mold release agent, and after mixing the same, the mixture is sieved, and molded into a shape of ball, slice, strip, block or honeycomb through adopting pelleting, mould pressing, extruding or other processes.

It can be undoubtedly obtained through the following method and test results of the fire-extinguishing composition that the efficiency of the fire-extinguishing composition of the present invention is obviously superior to that of the existing fire extinguishing agents, and the fire extinguishing time is also greatly shortened.

The composition is tested using the following proportions, and the specific test results are as follows:

### EMBODIMENTS

Take a specific mass percentage of the nitrogen-containing organic compound, a specific mass percentage of the auxiliary fire-extinguishing material and a specific mass percentage of additive in proportion, use water as a solvent, pelletize by using a 20-mesh sieve, then add a specific mass percentage of magnesium stearate as a mold release agent, mix the same, screen by a 15-mesh sieve, make it into slices, take 50 g of it, and put it into a fire extinguishing device filled with 50 g of a type K aerosol generating agent. The fire extinguishing effects are shown in Table 1-Table 6.

### COMPARATIVE EXAMPLE 1

Use a fire extinguishing device sample containing 50 g of a K salt type aerosol fire extinguishing agent and perform a fire extinguishing experiment according to a fire extinguishing experiment model. The fire extinguishing effect is shown in the tables.

### COMPARATIVE EXAMPLE 2

Use a fire extinguishing device sample containing 50 g of a type S aerosol fire extinguishing agent and perform a fire extinguishing experiment according to the fire extinguishing experiment model. The fire extinguishing effect is shown in the tables.

Fire extinguishing experiment model: an oil tray fire extinguishing experiment

The formulae of the fire-extinguishing composition of the present invention undergo 93# gasoline 8B fire extinguishing experiments with an implementing area of 25 m² by the experiment method described in 6.3.2.1 of GA86-2009 Simplified Fire Extinguisher standard. Experiment is performed for three times for each formula. Fire extinguishing effects and fire extinguishing time are recorded. The experimental results are shown in the tables below:

TABLE 1
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 1 | 2 | 3 | 4 | 5 | 6 | 7 | example 1 | example 2 |
| Commercial type | | | | | | | | | |
| K aerosol | | | | | | | | | |
| Commercial type | | | | | | | | | |
| S aerosol | | | | | | | | | |
| Indazole | 100 | | | | | | | | |
| Imidazole | | 96 | | | | | | | |
| Pyrazole | | | 96 | | | | | | |
| Pyrimidine | | | | 95 | | | | | |
| Piperazine | | | | | 94 | | | | |
| Iminostilbene | | | | | | 94 | | | |
| Diazacyclo | | | | | | | 93 | | |
| Magnesium | 0 | 2 | 2 | 3 | 4 | 4 | 5 | | |
| stearate | | | | | | | | | |
| Hydroxymethyl | 0 | 2 | 2 | 2 | 2 | 2 | 2 | | |
| propyl cellulose | | | | | | | | | |
| Nozzle | 610 | 700 | 653 | 641 | 733 | 805 | 743 | 1366 | 1254 |
| temperature ° C. | | | | | | | | | |
| Fire extinguishing | Full Ex- | 2 Ex- | 2 Ex- | Full Ex- | 2 Ex- | Full Ex- | Full Ex- | No Ex- | No Ex- |
| performance | tinctions | tinctions | tinctions | tinctions | tinctions | tinctions | tinctions | tinction | tinction |
| | | out of 3 | out of 3 | | out of 3 | | | | |
| Fire extinguishing | 4 | 10 | 9 | 4 | 10 | 6 | 4 | | |
| time s | | | | | | | | | |

TABLE 2
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 8 | 9 | 10 | 11 | 12 | 13 | 14 | example 1 | example 2 |
| Commercial type | | | | | | | | | |
| K aerosol | | | | | | | | | |
| Commercial type | | | | | | | | | |
| S aerosol | | | | | | | | | |
| Dithiane | 100 | | | | | | | | |
| Cycloxydim | | 96 | | | | | | | |
| Benzothiophene | | | 95 | | | | | | |
| Methyl | | | | 95 | | | | | |
| 3-(aminosulfonyl)- | | | | | | | | | |
| 2-thiophene- | | | | | | | | | |
| carboxylate | | | | | | | | | |
| Phenothiazine | | | | | 94 | | | | |
| Quinuclidine | | | | | | 94 | | | |
| Porphyrin | | | | | | | 93 | | |
| Magnesium | 0 | 2 | 3 | 3 | 4 | 3 | 5 | | |
| stearate | | | | | | | | | |
| Hydroxymethyl | 0 | 2 | 2 | 2 | 2 | 2 | 2 | | |
| propyl cellulose | | | | | | | | | |
| Nozzle | 756 | 766 | 789 | 823 | 659 | 677 | 804 | 1366 | 1254 |
| temperature ° C. | | | | | | | | | |
| Fire extinguishing | Full Ex- | Full Ex- | Full Ex- | 2 Ex- | 2 Ex- | Full Ex- | Full Ex- | No Ex- | No Ex- |
| performance | tinctions | tinctions | tinctions | tinctions | tinctions | tinctions | tinctions | tinction | tinction |
| | | | | out of 3 | out of 3 | | | | |
| Fire extinguishing | 4 | 4 | 5 | 9 | 8 | 5 | 4 | | |
| time s | | | | | | | | | |

TABLE 3
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 15 | 16 | 17 | 18 | 19 | 20 | 21 | example 1 | example 2 |
| Commercial type | | | | | | | | | |
| K aerosol | | | | | | | | | |
| Commercial type | | | | | | | | | |
| S aerosol | | | | | | | | | |
| Trioxane | 100 | | | | | | | | |
| Xanthene | | 95 | | | | | | | |
| Xanthone | | | 95 | | | | | | |
| Coumarin | | | | 95 | | | | | |
| Furazolidone | | | | | 94 | | | | |
| Dibenzofuran | | | | | | 93 | | | |
| Benzbromarone | | | | | | | 93 | | |
| Magnesium | 0 | 3 | 3 | 3 | 4 | 5 | 5 | | |
| stearate | | | | | | | | | |
| Hydroxymethyl | 0 | 2 | 2 | 2 | 2 | 2 | 2 | | |
| propyl cellulose | | | | | | | | | |
| Nozzle | 758 | 738 | 844 | 826 | 769 | 667 | 697 | 1366 | 1254 |
| temperature ° C. | | | | | | | | | |
| Fire extinguishing | Full Ex- | 2 Ex- | Full Ex- | 2 Ex- | 2 Ex- | Full Ex- | Full Ex- | No Ex- | No Ex- |
| performance | tinctions | tinctions | tinctions | tinctions | tinctions | tinctions | tinctions | tinction | tinction |
| | | out of 3 | | out of 3 | out of 3 | | | | |
| Fire extinguishing | 4 | 10 | 3 | 9 | 9 | 5 | 6 | | |
| time s | | | | | | | | | |

TABLE 4
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 22 | 23 | 24 | 25 | 26 | 27 | 28 | example 1 | example 2 |
| Commercial type | | | | | | | | | |
| K aerosol | | | | | | | | | |
| Commercial type | | | | | | | | | |
| S aerosol | | | | | | | | | |
| Indazole | 50 | | | | | | | | |
| Imidazole | | 51 | | | 20 | | | | |
| Pyrazole | | | 63 | | | | | | |
| Pyrimidine | | | | 70 | | | | | |
| Piperazine | | | | | 59 | | | | |
| Iminostilbene | | | | | | 86 | | | |
| Diazacyclo | | | | | | | 90 | | |
| Ammonium | 30 | | | | | | 5 | | |
| polyphosphate | | | | | | | | | |
| Melamine | | 22 | | 13 | | | | | |
| Monopotassium | | 23 | | | | 13.9 | | | |
| phosphate | | | | | | | | | |
| Sodium | 16 | | | | 4 | | | | |
| bicarbonate | | | | | | | | | |
| Aluminum | | | 13 | | 7 | | | | |
| hydroxide | | | | | | | | | |
| Dicyandiamide | | | 20 | 13 | | | | | |
| Magnesium | 2 | 2 | 2 | 2 | 5 | 0.05 | 3 | | |
| stearate | | | | | | | | | |
| Hydroxymethyl | 2 | 2 | 2 | 2 | 5 | 0.05 | 2 | | |
| propyl cellulose | | | | | | | | | |
| Nozzle | 713 | 823 | 843 | 850 | 901 | 831 | 611 | 1366 | 1254 |
| temperature e ° C. | | | | | | | | | |
| Fire extinguishing | Full Ex- | Full Ex- | Full Ex- | Full Ex- | 2 Ex- | Full Ex- | Full Ex- | No Ex- | No Ex- |
| performance | tinctions | tinctions | tinctions | tinctions | tinctions | tinctions | tinctions | tinction | tinction |
| | | | | | out of 3 | | | | |
| Fire extinguishing | 3 | 4 | 4 | 4 | 9 | 5 | 4 | | |
| time s | | | | | | | | | |

TABLE 5
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 29 | 30 | 31 | 32 | 33 | 34 | 35 | example 1 | example 2 |
| Commercial type | | | | | | | | | |
| K aerosol | | | | | | | | | |
| Commercial type | | | | | | | | | |
| S aerosol | | | | | | | | | |
| Dithiane | 50 | | | | | | | | |
| Cycloxydim | | 51 | | | | | | | |
| benzothiophene | | | 44 | | | | | | |
| Methyl | | | 21 | 72 | | | | | |
| 3-(aminosulfonyl)- | | | | | | | | | |
| 2-thiophene- | | | | | | | | | |
| carboxylate | | | | | | | | | |
| Phenothiazine | | | | | 80 | | | | |
| Quinuclidine | | | | | | 84 | | | |
| porphyrin | | | | | | | 90 | | |
| Ammonium | 30 | | | | | 6 | | | |
| polyphosphate | | | | | | | | | |
| Melamine | | 18 | | 14 | | | 5 | | |
| Monopotassium | | 33 | | | | 8.9 | | | |
| phosphate | | | | | | | | | |
| Sodium | 16 | | | | 3 | | | | |
| bicarbonate | | | | | | | | | |
| Aluminum | | | 14 | | 7 | | | | |
| hydroxide | | | | | | | | | |
| Dicyandiamide | | | 17 | 10 | | | | | |
| Magnesium | 2 | 2 | 2 | 2 | 5 | 0.05 | 3 | | |
| stearate | | | | | | | | | |
| Hydroxymethyl | 2 | 2 | 2 | 2 | 5 | 0.05 | 2 | | |
| propyl cellulose | | | | | | | | | |
| Nozzle | 666 | 796 | 719 | 846 | 753 | 680 | 872 | 1366 | 1254 |
| temperature ° C. | | | | | | | | | |
| Fire extinguishing | Full Ex- | Full Ex- | 2 Ex- | Full Ex- | 2 Ex- | Full Ex- | Full Ex- | No Ex- | No Ex- |
| performance | tinctions | tinctions | tinctions | tinctions | tinctions | tinctions | tinctions | tinction | tinction |
| | | | out of 3 | | out of 3 | | | | |
| Fire extinguishing | 3 | 4 | 9 | 4 | 10 | 5 | 4 | | |
| time s | | | | | | | | | |

TABLE 6
Comparison of various components and ingredients and comparison of fire extinguishing test results thereof

| | Embodiment component content (mass percentage) | | | | | | | Comparative | Comparative |
|---|---|---|---|---|---|---|---|---|---|
| Component | 36 | 37 | 38 | 39 | 40 | 41 | 42 | example 1 | example 2 |
| Commercial type | | | | | | | | | |
| K aerosol | | | | | | | | | |
| Commercial type | | | | | | | | | |
| S aerosol | | | | | | | | | |
| Trioxane | 50 | | | | | | | | |
| Xanthene | | 51 | | | | | | | |
| Xanthone | | | 65 | 31 | | | | | |
| Coumarin | | | | 39 | | | | | |
| Furazolidone | | | | | 75 | | | | |
| Dibenzofuran | | | | | | 80 | | | |
| Benzbromarone | | | | | | | 90 | | |
| Ammonium | | 20 | | | | 10 | | | |
| polyphosphate | | | | | | | | | |
| Melamine | 30 | | | 14 | | | | | |
| Monopotassium | | 25 | | | | | 5 | | |
| phosphate | | | | | | | | | |
| Sodium | | | 14 | | 8 | | | | |
| bicarbonate | | | | | | | | | |
| Aluminum | | | | 14 | 7 | | | | |
| hydroxide | | | | | | | | | |
| Dicyandiamide | 16 | | 17 | | | 8.9 | | | |
| Magnesium | 2 | 2 | 2 | 2 | 5 | 0.05 | 3 | | |
| stearate | | | | | | | | | |
| Hydroxymethyl | 2 | 2 | 2 | 2 | 5 | 0.05 | 2 | | |
| propyl cellulose | | | | | | | | | |
| Nozzle | 756 | 823 | 755 | 682 | 699 | 753 | 809 | 1366 | 1254 |
| temperature ° C. | | | | | | | | | |
| Fire extinguishing | Full Ex- | 2 Ex- | Full Ex- | Full Ex- | 2 Ex- | 2 Ex- | Full Ex- | No Ex- | No Ex- |
| performance | tinctions | tinctions | tinctions | tinctions | tinctions | tinctions | tinctions | tinction | tinction |
| | | out of 3 | | | out of 3 | out of 3 | | | |
| Fire extinguishing | 3 | 8 | 4 | 4 | 8 | 8 | 4 | | |
| time s | | | | | | | | | |

The foregoing embodiments are merely explanations to the preferred schemes of the present invention, and are not the limitation to the present invention. All changes and modifications to the foregoing embodiments within the essential spirit scope of the present invention should fall within the scope of protection of the claims of the present application.

1. A fire-extinguishing composition containing a heterocyclic compound, wherein the fire-extinguishing composition contains a heterocyclic compound; the fire-extinguishing composition releases a great quantity of active fire-extinguishing particles by making use of combustion of a pyrotechnic agent.

2. The fire-extinguishing composition containing a heterocyclic compound according to claim 1, wherein the mass content of the heterocyclic compound in the fire-extinguishing composition is 35% or above.

3. The fire-extinguishing composition containing a heterocyclic compound according to claim 1, wherein the heterocyclic compound comprises one or more of a nitrogen-containing heterocyclic organic compound, a sulfur-containing heterocyclic organic compound, and an oxygen-containing heterocyclic organic compound.

4. The fire-extinguishing composition containing a heterocyclic compound according to claim 3, wherein the nitrogen-containing heterocyclic organic compound comprises: indazole, pyrazole, chlortrimeton, imidazole, triazole, tetrazole, pentazole, pyrazine, triazine, tetrazine, pentazine, hexazine, pyridazine, pyrimidine, piperidine, piperazine, oxazine, azepine, caprolactam, iminostilbene, diazacyclo, indole, isoindole, carbazole, benzimidazole, carboline, benzotriazole, purine, uric acid, quinoline, quinazoline, phthalazine, acridine, phenanthridine, phenazine, phenoxazine, pteridine, orthophenanthroline, 1,4-diazine, 1,4-diazabicyclo[2.2.2]octane and cyclodextrin.

5. The fire-extinguishing composition containing a heterocyclic compound according to claim 3, wherein the sulfur-containing heterocyclic organic compound comprises: dithiane, cycloxydim, tetrahydrothiapyran-4-one, benzothiophene, dibenzothiophene, methyl 3-(aminosulfonyl)-2-thiophenecarboxylate, polythiophene, 2-thiopheneacetic acid, 5,5′-dibromo-2,2′-bisthiophene, benzothiophene-3-carbaldehyde, terthienyl, thifensulfuron, 2-bromo-5-benzoylthiophene, phenothiazine, 2-(trifluoromethyl) phenothiazine, 2-acetylphenothiazine, hydrochlorothiazide, chlorpromazine, chlorpromazine hydrochloride, promethazine hydrochloride, quinuclidine, porphyrin, tetraphenylporphyrin, protoporphyrin disodium, protoporphyrin IX dimethyl ester, protoporphyrin and copper tetraphenylporphyrin.

6. The fire-extinguishing composition containing a heterocyclic compound according to claim 3, wherein the oxygen-containing heterocyclic organic compound comprises: trioxane, sym-trioxane, oxetane, xanthene, xanthone, 1,8-dihydroxy-3,5-dimethoxyxanthone, 1,8-dihydroxy-3,7-dimethoxyxanthone, 1-hydroxy-3,7,8-trimethoxyxanthone, 1-hydroxy-2,3,4,5-tetramethoxyxanthone, 1-hydroxy-2,3,5-trimethoxyxanthone, coumarin, thiamine tetrahydrofuryl disulfide, furazolidone, furaltadone, furadantin, furacilin, furanose, furoic acid, furosemide, furapyrimidone, dibenzofuran and benzbromarone.

7. The heterocyclic fire-extinguishing composition according to claim wherein the fire-extinguishing composition further comprises an auxiliary fire-extinguishing material.

8. The fire-extinguishing composition containing a heterocyclic compound according to claim 7, wherein the auxiliary fire-extinguishing material comprises: brominated flame retardants, chlorinated flame retardants, organophosphorus flame retardants, phosphorus-halogen flame retardants, nitrogen flame retardants, phosphorus-nitrogen flame retardants, inorganic flame retardants or any of their combinations.

9. The fire-extinguishing composition containing a heterocyclic compound according to claim 7, wherein the fire-extinguishing composition further comprises an additive and the content of the additive is 0.1-10%.

10. The fire-extinguishing composition containing a heterocyclic compound according to claim 9, wherein the additive is one or more of stearate, graphite, sodium silicate, phenolic resin, shellac, starch, dextrin, rubber, epoxy resin, acetal adhesive and hydroxypropyl methyl cellulose.

11. The fire-extinguishing composition containing a heterocyclic compound according to claim 10, wherein the components of the fire-extinguishing composition and their mass percentages are:

| | |
|---|---|
| the heterocyclic compound | 35%-96% |
| the auxiliary fire-extinguishing material | 3%-60% |
| the additive | 1%-10%. |

12. The fire-extinguishing composition containing a heterocyclic compound according to claim 11, wherein the components of the fire-extinguishing composition and their mass percentages are:

| | |
|---|---|
| the heterocyclic compound | 50%-90% |
| the auxiliary fire-extinguishing material | 5%-45% |
| the additive | 2%-8%. |

13. The fire-extinguishing composition containing a heterocyclic compound according to claim 2, wherein the heterocyclic compound comprises one or more of a nitrogen-containing heterocyclic organic compound, a sulfur-containing heterocyclic organic compound, and an oxygen-containing heterocyclic organic compound.

14. The heterocyclic fire-extinguishing composition according to claim 5, wherein the fire-extinguishing composition further comprises an auxiliary fire-extinguishing material.

15. The heterocyclic fire-extinguishing composition according to claim 6, wherein the fire-extinguishing composition further comprises an auxiliary fire-extinguishing material.
